(19) United States
(12) Patent Application Publication
(10) Pub. No.: US 2011/0012788 A1
(43) Pub. Date: Jan. 20, 2011

(54) Miniature Circularly Polarized Folded Patch Antenna

(75) Inventors: Corbett R. Rowell, Mongkok (CN); Hau Wah Lai, Kowloon (CN)

Correspondence Address: FULBRIGHT & JAWORSKI L.L.P, 2200 ROSS AVENUE, SUITE 2800, DALLAS, TX, 75201-2784, US

(73) Assignee: Hong Kong Applied Science and Technology Research Institute Co., Ltd., Shatin (CN)

(21) Appl. No.: 12/502,939

(22) Filed: Jul. 14, 2009

(51) Int. Cl. H01Q 1/38; H01P 11/00

(52) U.S. Cl. 343/700 MS; 29/600

(57) ABSTRACT

An antenna system comprising a ground plane, an antenna element folded under itself and operable to transmit and receive circularly polarized signals, an air filled cavity disposed between the ground plane and the antenna element, and a radio frequency module in communication with the antenna element.

### TECHNICAL FIELD

The present description relates to antennas. More specifically, the present description relates to patch antennas for transmitting and/or receiving circularly polarized signals.

### BACKGROUND OF THE INVENTION

A large number of radio applications, including satellite communication, global positioning system (GPS), and radio frequency identification (RFID) base stations, utilize circularly polarized signals. Circular polarization (CP) of electromagnetic radiation is a polarization such that the electric field of the radiation varies in two orthogonal planes (the major and minor axis) with the same magnitude. Perfect CP is where the major and minor components are of equal magnitude and 90° out of phase. Most real world CP signals are not perfectly circular; rather, the signals are elliptical. That is, the orthogonal components are not of equal amplitude or not strictly 90° out of phase. The quality of circular polarization is quantified as the axial ratio. Axial ratio is defined as the voltage ratio of the major axis to the minor axis of the polarization ellipse and is expressed in decibels (dB). An axial ratio of less than 3 dB is considered sufficient for most CP applications. For a good circularly polarized antenna design, axial ratio bandwidth (the frequency band having axial ratio below 3 dB) is necessarily ranged inside the impedance bandwidth. This ensures that the received or transmitted CP signal of the antenna has maximum power transfer.

Microstrip or patch antennas are increasingly used in GPS, satellite communications, personal communication systems, and other communication systems that utilize circularly polarized signals. A patch antenna is a resonator-type antenna that generally includes an electrically conductive ground layer, an electrically conductive patch antenna element, a feeding geometry, and a dielectric substrate or an air filled cavity disposed between the ground layer and conductive patch antenna element. There are two primary approaches to accomplish circular polarization in patch antennas.

One approach is to excite a single patch with two feeds, with one feed delayed by 90° with respect to the other. This drives two transverse modes with equal amplitudes and 90° out of phase. Each mode radiates separately, and the modes combine to produce circular polarization. A second approach is to use a single feed but introduce an asymmetry into the patch, causing current distribution to be displaced. The resonance frequencies of the two paths can be adjusted so that the phase difference between the two paths is 90°. Thus circular polarization can be achieved by building a patch with two resonance frequencies in orthogonal directions.

Prior art CP patch antennas are typically in the range of half a wavelength in length. Prior art patch antennas utilize several different technologies to enable miniaturization (length<0.2λ₀). The most common solution is dielectric loading with high dielectric constant material, but there are several drawbacks with this method. Dielectrically loaded patch antennas often exhibit narrow bandwidth, high loss, and poor efficiency. Moreover, dielectrically loaded patch antennas are often expensive, heavy, and difficult to manufacture.

### BRIEF SUMMARY OF THE INVENTION

Various embodiments of the invention are directed to antenna systems that include a ground plane, an antenna element folded under itself and with asymmetries that allow the antenna element to generate and receive circularly polarized signals, an air filled cavity disposed between the ground plane and the antenna element, and a radio frequency module in communication with the antenna element and transmitting and receiving radio waves through the antenna element.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1A illustrates a side view of a circularly polarized folded patch antenna according to an embodiment of the present invention.

FIG. 1B illustrates a top view of a circularly polarized folded patch antenna according to an embodiment of the present invention.

FIG. 1C illustrates a plan view of a patch radiating element according to an embodiment of the present invention.

FIG. 2A illustrates the measured axial ratio against frequency of a prototype circularly polarized folded patch antenna built and tested according to the embodiment illustrated by FIGS. 1A-1C.

FIG. 2B illustrates the measured return loss against frequency of a prototype circularly polarized folded patch antenna built and tested according to the embodiment illustrated by FIGS. 1A-1C.

FIG. 2C illustrates a right hand CP radiation pattern at the phi=0° plane at 1.554 GHz for the embodiment of the prototype circularly polarized folded patch antenna built and tested according to the embodiment illustrated by FIGS. 1A-1C.

FIG. 2D illustrates a right hand CP radiation pattern at the phi=90° plane at 1.554 GHz for the embodiment of the prototype circularly polarized folded patch antenna built and tested according to the embodiment illustrated by FIGS. 1A-1C.

FIG. 3A illustrates an exemplary patch geometry according to an embodiment of the present invention, wherein asymmetry is introduced into the top layer of the radiating element of a circularly polarized folded patch antenna.

FIG. 3B illustrates an exemplary patch geometry according to an embodiment of the present invention, wherein asymmetry is introduced into the top layer of the radiating element of a circularly polarized folded patch antenna.

FIG. 3C illustrates an exemplary patch geometry according to an embodiment of the present invention, wherein asymmetry is introduced into the top layer of the radiating element of a circularly polarized folded patch antenna.

FIG. 4A illustrates an exemplary patch geometry according to an embodiment of the present invention, wherein asymmetry is introduced into the bottom layer of the radiating element of a circularly polarized folded patch antenna.

FIG. 4B illustrates an exemplary patch geometry according to an embodiment of the present invention, wherein asymmetry is introduced into the bottom layer of the radiating element of a circularly polarized folded patch antenna.

FIG. 5A illustrates a side view of circularly polarized folded patch antenna according to an embodiment of the present invention, wherein asymmetry is introduced into the radiating element by lengthening a vertical wall portion of the radiating element.

FIG. 5B illustrates a plan view of a patch radiating element according to an embodiment of the present invention.

FIG. 6A illustrates a side view of circularly polarized folded patch antenna according to an embodiment of the present invention, wherein the radiating element is folded downwards to form a radiating element with more than two parallel layers.

FIG. 6B illustrates a plan view of a patch radiating element according to an embodiment of the present invention.

FIG. 7A illustrates a side view of circularly polarized folded patch antenna according to an embodiment of the present invention, wherein the radiating element is folded upwards to form a radiating element with more than two parallel layers.

FIG. 7B illustrates a plan view of a patch radiating element according to an embodiment of the present invention.

FIG. 8A illustrates the perspective view of a circularly polarized folded patch antenna according to an embodiment of the present invention wherein the radiating element comprises a conductor on PCB material.

FIG. 8B illustrates a side view of the circularly polarized folded patch antenna illustrated by FIG. 8A.

FIG. 8C illustrates the top layer of the radiating element of the circularly polarized folded patch antenna illustrated by FIG. 8A.

FIG. 8D illustrates the bottom layer of the radiating element of the circularly polarized folded patch antenna illustrated by FIG. 8A.

FIG. 8E illustrates the bottom layer of the radiating element of the circularly polarized folded patch antenna illustrated by FIG. 8A wherein the tails on the bottom layer are connected.

FIG. 9 illustrates an exemplary patch geometry according to an embodiment of the present invention wherein the radiating element includes dual feed points.

### DETAILED DESCRIPTION OF THE INVENTION

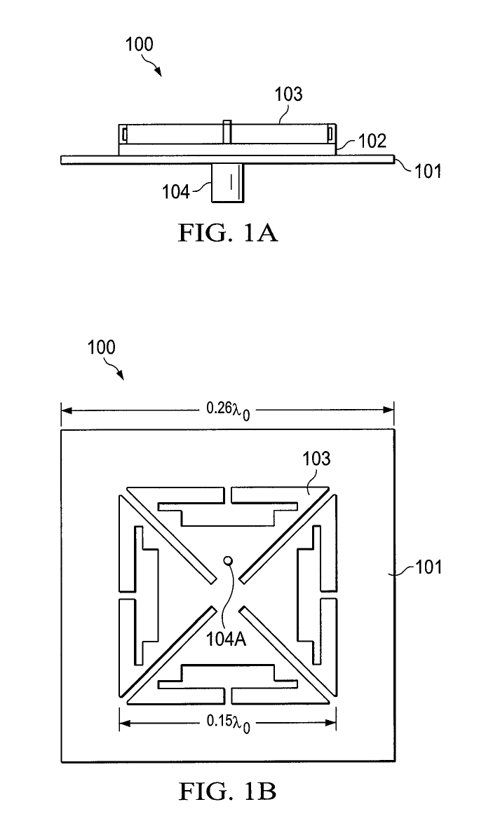

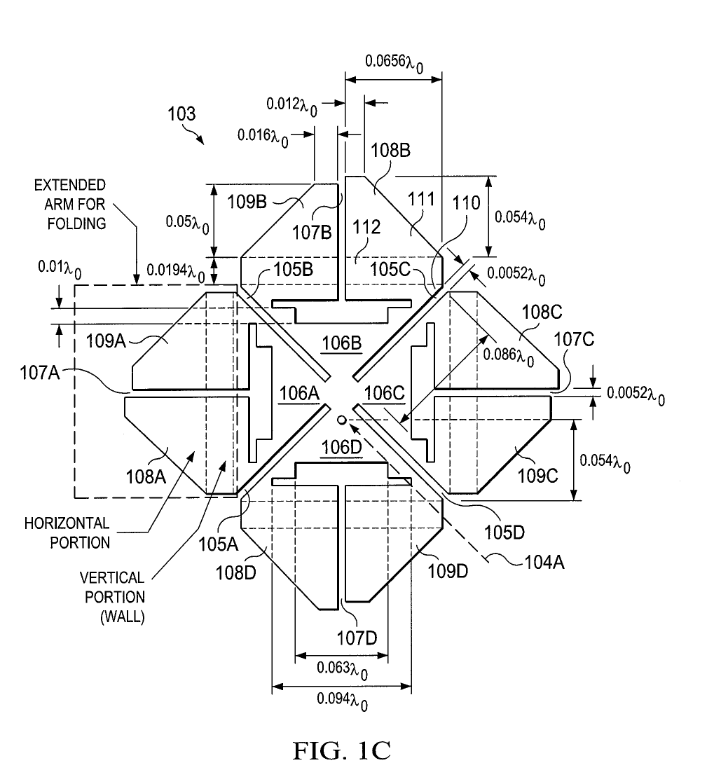

FIGS. 1A and 1B illustrate a miniature circularly polarized folded patch antenna 100 adapted according to an exemplary embodiment of the present invention. FIG. 1A is a side view illustration of exemplary folded patch antenna 100. Antenna 100 includes a ground plane 101, a spacer layer 102, a radiating element 103, and a radio frequency (RF) feed 104. As illustrated by FIG. 1A and discussed further with respect to FIG. 1C, radiating element 103 is folded under itself to form a folded patch.

FIG. 1B is a top view illustration of the exemplary folded patch antenna 100. As illustrated by FIG. 1B, radiating element 103 includes a plurality of slots, which will be discussed further with respect to FIG. 1C, and includes a RF feed point 104A. As discussed further below, the center conductor of a coaxial cable is coupled to radiating element 103 at RF feed point 104A.

In the example of FIGS. 1A and 1B, ground plane 101 includes a planar substrate, such as a printed circuit board, covered by metal (e.g., copper in the example of FIGS. 1A and 1B). In the embodiment illustrated by FIGS. 1A and 1B, the square ground plane is 0.26 λ₀. Furthermore, in some embodiments, the planar substrate and conducting material may be separated by a dielectric or by an air gap.

Spacer layer 102 is composed of a porous, light weight, non-conductive material that consists primarily of air. In the exemplary embodiment of FIGS. 1A and 1B, spacer layer 102 is a foam spacer, which has a dielectric constant similar to air. In other embodiments, spacer layer 102 can be made of, for example, glass or TEFLON®. In still other embodiments, spacer layer 102 may be created using standoffs (e.g., insulator pins, dielectric spacers, etc.) to create an air gap between ground plane 101 and radiating element 103. And in certain embodiments, a signal line from RF feed 104 holds radiating element 103 above ground plane 101, creating an air gap between ground plane 101 and radiating element 103.

In the embodiment illustrated by FIGS. 1A and 1B, radiating element 103 is coupled to a transmitter or receiver by a coaxial cable which is fed to RF feed 104. The center conductor of the coaxial cable extends vertically up through the spacer layer 102 and is fixed to radiating element 103 by soldering at RF feed point 104A.

According to the embodiment of the present invention illustrated by FIGS. 1A and 1B, radiating element 103 is shaped into a folded patch. The radiating element 103 is formed from a conducting material (copper in the example of FIGS. 1A and 1B). In other embodiments the radiating element may be formed from other conductors, such as aluminum, gold, or tin plated steel. The geometry of radiating element 103 comprises a unique configuration described with reference to FIG. 1C.

FIG. 1C shows a plan view of radiating element 103 according to the embodiment of the invention illustrated by FIGS. 1A and 1B. As shown in FIG. 1C, radiating element 103 is formed from a single sheet of a conductor (e.g., copper) that can be stamped, cut, or otherwise formed to provide the geometries disclosed herein. Radiating element 103 includes a plurality of slots and asymmetries cut, or otherwise formed, in radiating element 103. The slots have several purposes. For instance, the slots lengthen the effective radiating current path of radiating element 103, thereby allowing reduction of the radiating element's size. Also, the slots and asymmetries introduce radiating current paths of differing lengths, which allows excitation of two modes. The asymmetries are designed to ensure that the current paths produce two signals of substantially equal magnitude and 90° out of phase and are described in more detail below.

In the embodiment illustrated by FIG. 1C, radiating element 103 includes slots 105A-105D. Each of slots 105A-105D radiates inwardly towards the center of radiating element 103. Each of slots 105A-105D is orthogonal to adjacent slots (i.e., the slots are at 90° angles to neighboring slots). Slots 105A-105D define arms 106A-106D.

Each of arms 106A-106D includes a slot 107A-107D, respectively, that defines two fingers. As shown in FIG. 1, each of arms 106A-106D is asymmetrical—the two fingers of each arm are different lengths. This asymmetry provides for radiation paths of different lengths within radiating element 103. That is, the different lengths of the fingers on allow radiating element 103 to generate and/or receive CP signals. The lengths are selected to cause simultaneous excitation of two orthogonal patch modes substantially equal in amplitude and 90° out of phase.

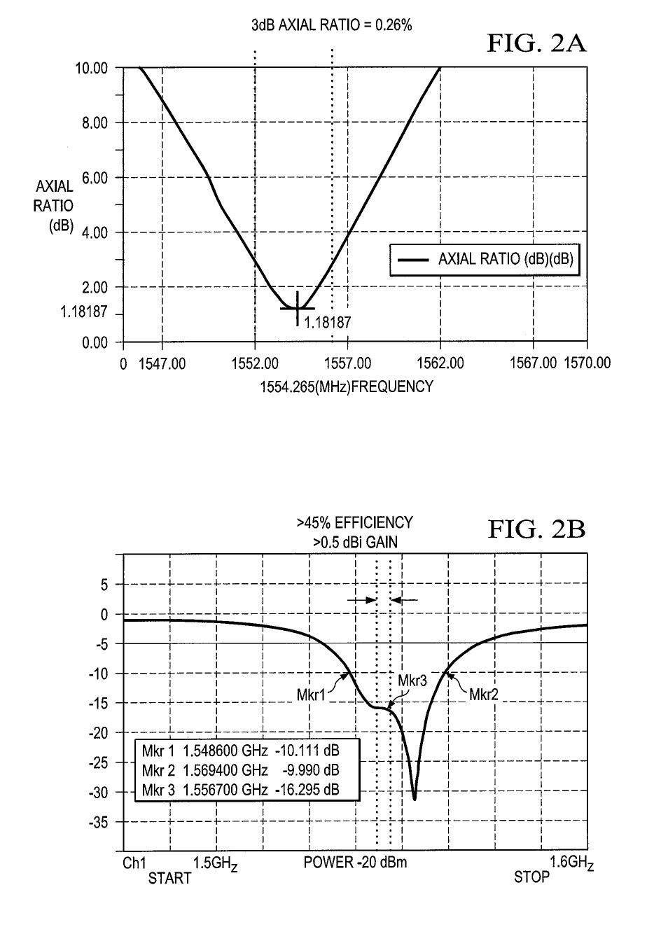

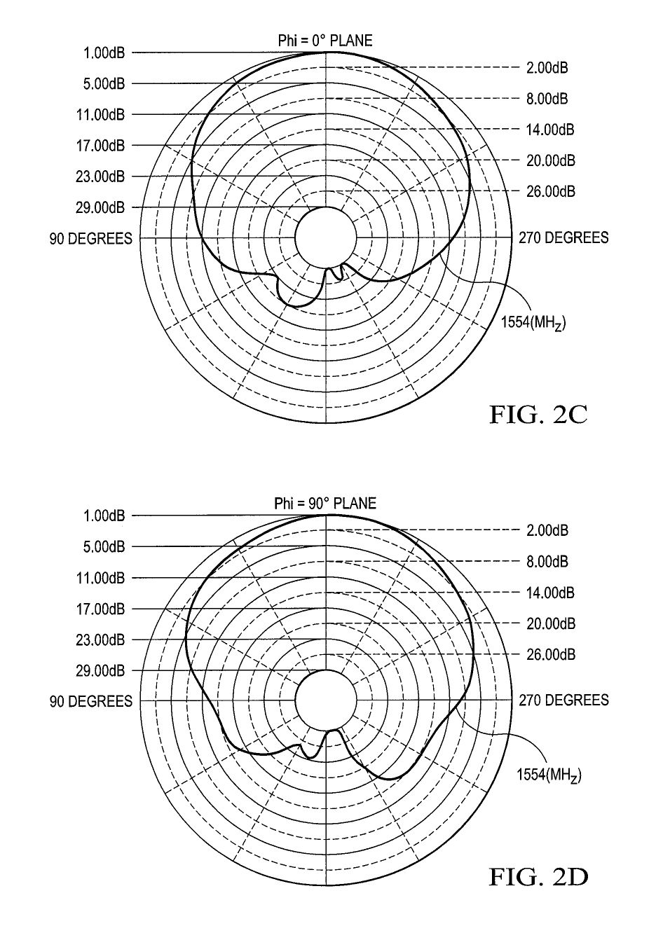

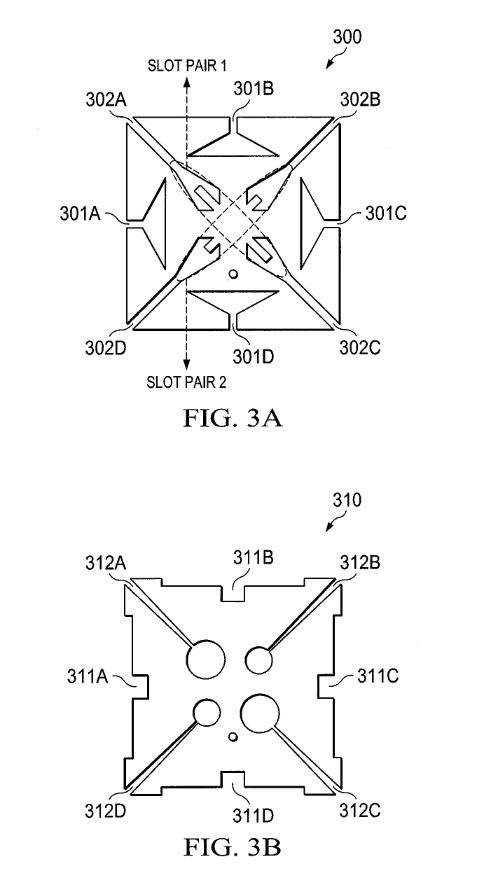

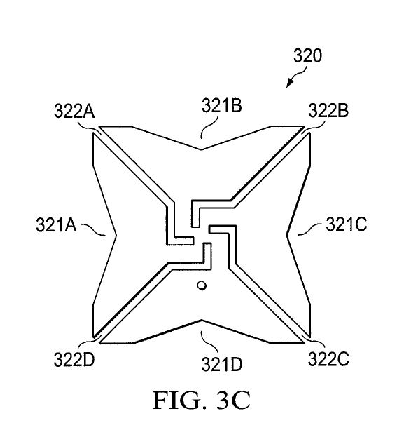

FIG. 1C illustrates the dimensions of radiating element 103 in terms of λ₀ . The dimensions of slots 105A-105D are identical. Similarly, the dimensions of slots 107A-107D are identical. Consequently, the dimensions of arms 106A-106D and fingers 108A-108D and 109A-109D are identical; however, as illustrated in FIG. 3, the arms are oriented differently. As discussed further below, with respect to FIGS. 2A-2D, the disclosed pattern can be used to generate and receive circularly polarized signals.

To further reduce the lateral size of radiating element 103, radiating element 103 is designed to fold under itself. According to the embodiment illustrated by FIG. 1C, radiating element 103 is designed to fold along fold lines, which are shown as dashed lines on the illustration of radiating element 103 shown in FIG. 1C. The dashed fold lines shown in FIG. 1C are for illustration only as other embodiments may be folded differently. In the embodiment of FIGS. 1A-1C, the radiating element is designed to be folded down and under itself at approximately 90° angles along the fold lines. When folded along the fold lines, radiating element 103 includes a top layer 110, bottom layer 111, and vertical wall layers 112. In certain embodiments, radiating element 103 may be folded around a spacer element (not shown). The spacer element may comprise, for example, a porous, light weight, non-conductive material that consists primarily of air (e.g., foam, non-woven fabric, etc.).

As shown in FIG. 1B, the length of the radiating element for the disclosed patch antenna is on the order of 0.15 λ₀. Miniaturization of the disclosed circularly polarized folded patch antenna is facilitated by at least two design elements. For instance, the introduction of slots into radiating element 103 causes radiation patterns that effectively lengthen the radiating element. Furthermore, the lateral size of the patch is reduced by folding radiating element 103 under itself. It should be noted that the disclosed miniaturization of antenna 100 is facilitated without utilizing dielectric loading, in contrast to some prior art CP patch antennas.

A prototype according to the design of the embodiment of FIGS. 1A-1C has been built and tested. The results of testing are shown in FIGS. 2A-2D. FIG. 2A illustrates the axial ratio of circularly polarized patch antenna 100. The antenna has an axial ratio of 1.18187 dB at 1554.265 MHz and exhibits an axial ratio of better than 3 dB for a range of frequencies. The antenna has a 3 dB axial ratio bandwidth of 0.26%. FIG. 2B illustrates the measured return loss of circularly polarized folded patch antenna 100. As shown in FIG. 2B, the disclosed antenna displays 1.33% impedance bandwidth of return loss below −10 dB. The axial ratio bandwidth is ranged inside the impedance bandwidth, which is the dotted line in FIG. 2A. The prototype antenna demonstrated greater than 45% efficiency and greater than 0.5 dB gain between the axial ratio bandwidth.

FIGS. 2C and 2D illustrate actual right hand CP radiation patterns for the embodiment of the circularly polarized patch antenna 100 illustrated and described with respect to FIGS. 1A-1C. FIG. 2C shows the radiation pattern for folded patch antenna 100 at the Φ=0° plane. FIG. 2D shows the radiation pattern for folded patch antenna 100 at the Φ=90° plane.

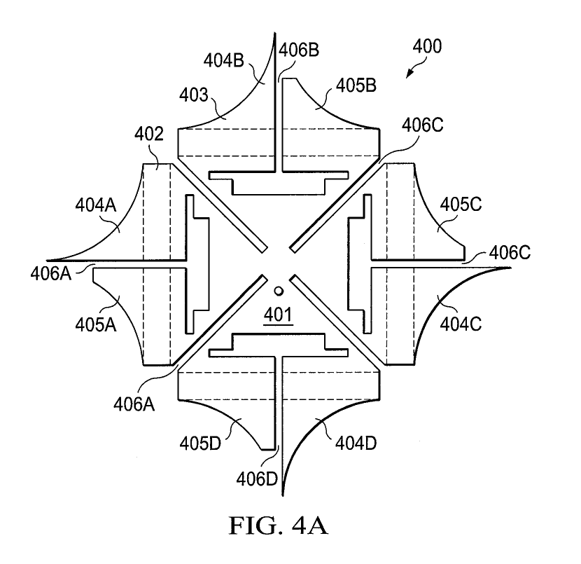

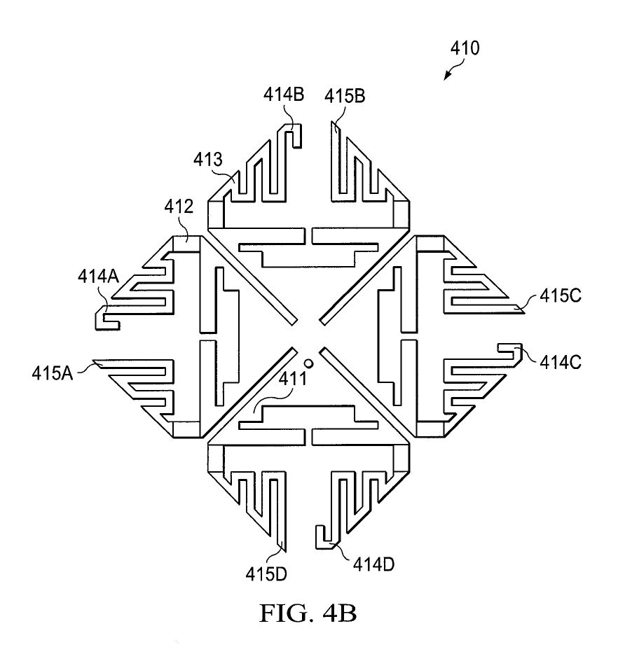

Although exemplary circularly polarized folded patch antenna 100 includes radiating element 103 of the geometry illustrated in FIG. 1C, folded patch antennas according to the present invention may include radiating elements of any geometry that excites two different orthogonal modes 90° out of phase and substantially equal in magnitude. FIGS. 3A-3C and 4A-4B illustrate exemplary patch geometries for use in embodiments of the present invention.

FIGS. 3A-3C illustrate embodiments of the present invention where asymmetries are introduced to the top layer of a folded radiating element. FIGS. 3A-3C do not show the vertical wall layers or bottom layers of the folded patch. The disclosed geometries are examples of the top layer of a radiating element of a circularly polarized folded patch antenna according to embodiments of the present invention.

A folded patch radiating element with a top layer according to the geometry illustrated by FIG. 3A has been shown to generate and receive circularly polarized signals. Top layer 300 includes a plurality of symmetrical slots 301A-301D on each side of the top layer. These slots effectively lengthen the radiating element by creating a meandering path. Top layer 300 also includes a first slot pair (slots 302A and 302C) and a second slot pair (slots 303B and 303D). As illustrated by FIG. 3A, the prongs of the first slot pair and second slot pair are of different lengths. The lengths of the slot prongs are selected to ensure that radiating element 300 excites two orthogonal modes 90° out of phase and substantially equal in magnitude.

FIG. 3B illustrates another top layer geometry capable of exciting two modes substantially equal in magnitude and 90° out of phase. Top layer 310 includes a plurality of symmetrical slots 311A-311D on each side of the top layer. Slots 311A-311D effectively lengthen the radiating element by creating longer paths. In the example of FIG. 3B, radiating circuits of different lengths are created based on the differences in the sizes of slots 312A-312D. Slots 312A-312D radiate inwards and terminate in circular areas. The circular area at the end of slots 312A and 312C has a larger area than the circular area at the ends of slots 312B and 312D. In this example, the size of the circular areas is selected to ensure that the radiating element 310 excites two orthogonal modes 90° out of phase.

FIG. 3C also illustrates a top layer geometry capable of exciting two modes substantially equal in magnitude and 90° out of phase. Top layer 320 includes a plurality of symmetrical slots 321A-321D on each side of the top layer. Slots 321A-321D effectively lengthens the radiating element by creating a meandering path. In the example of FIG. 3C, slots 322A-322D radiate inwards and turn outwards at approximately 45° and then inwards at approximately 90° to form a pinwheel-like pattern. The asymmetry in direction of the patches is selected to ensure that the radiating element excites two orthogonal modes 90° out of phase.

FIGS. 4A and 4B illustrate plan views of radiating elements according to embodiments of the present invention. Radiating elements 400 and 410 are designed to be folded along the illustrated fold lines to form a folded patch with a top layer (top layers 401 and 411), a vertical wall layer (vertical wall layers 402 and 412), and a bottom layer comprising four arms (bottom layer 403 and 413). As illustrated by FIGS. 4A and 4B, the top layers of radiating elements 400 and 410 are symmetrical. In these examples, the asymmetries that drive two orthogonal modes 90° out of phase are introduced in the bottom layers (403 and 413) of the folded patch radiating elements 400 and 410.

In the example of FIG. 4A, the asymmetry that facilitates circular polarization in radiating element 400 is introduced in each arm of bottom layer 403. Fingers 404A-404D and 405A-405D are defined by slots 406A-406D. As shown by FIG. 4A, fingers 404A-404D are longer than fingers 405A-405D. The lengths of the fingers are selected to cause radiating element 400 to excite two orthogonal modes 90° out of phase and substantially equal in magnitude.

In the example of FIG. 4B, the asymmetry that facilitates circular polarization in radiating element 410 is introduced in each arm of bottom layer 413. As shown by FIG. 4B, tails 414A-414D are longer than tails 415A-415D. The lengths of the tails are selected to cause radiating element 400 to excite two orthogonal modes 90° out of phase and substantially equal in magnitude.

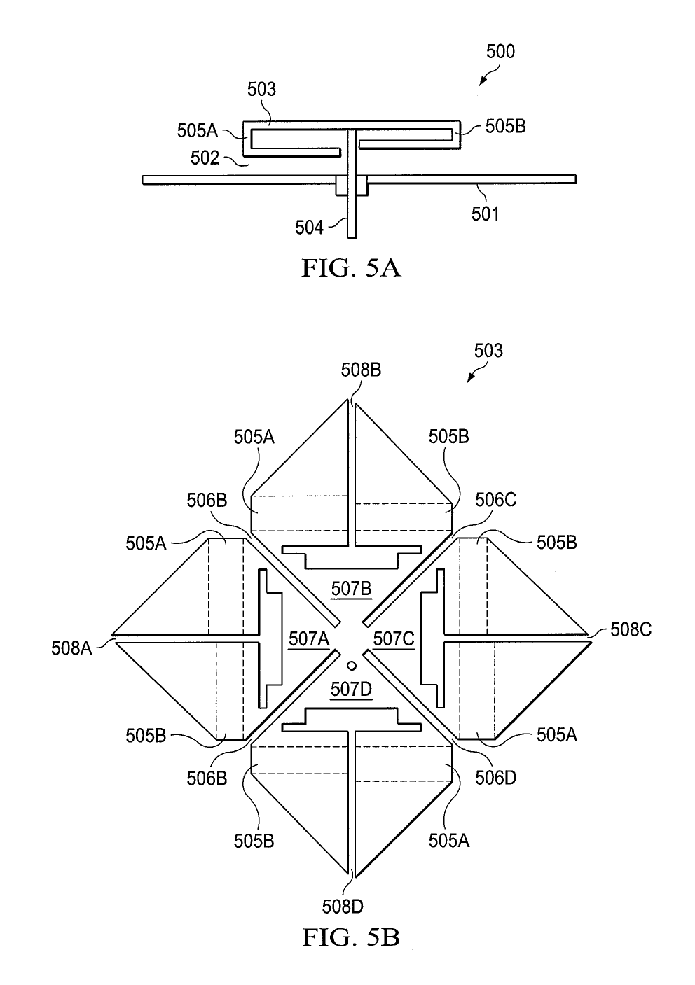

FIGS. 5A and 5B illustrate a circularly polarized folded patch antenna according to an embodiment of the present invention where the asymmetries are introduced using unequal wall heights. As shown in FIG. 5A, circularly polarized folded patch antenna 500 includes a ground plane 501, spacer layer 502, radiating element 503, and feed element 504. Radiating element 500 includes vertical walls 505A and 505B of different heights. The differences in vertical wall height create radiation circuits of different lengths and are selected to excite two orthogonal modes 90° out of phase.

FIG. 5B illustrates a plan view of radiating element 503. Radiating element 503 includes slots 506A-506D that defines arms 507A-507D. Each of arms 507A-507D includes two fingers of different lengths defined by slots 508A-508D. As shown in FIG. 5B, the dashed fold lines define vertical walls of unequal height. When radiating element 503 is folded under itself along the fold lines, walls 505A and 505B are formed with differing heights.

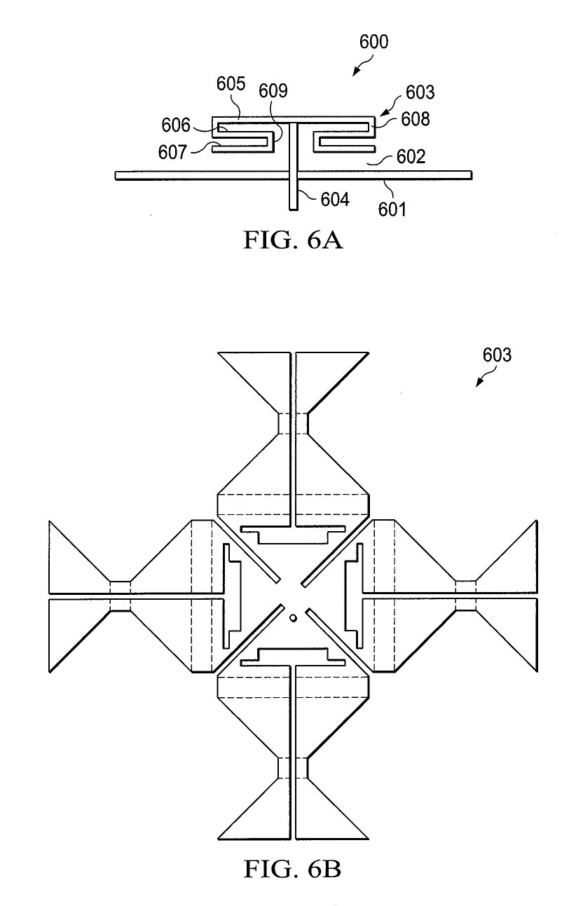

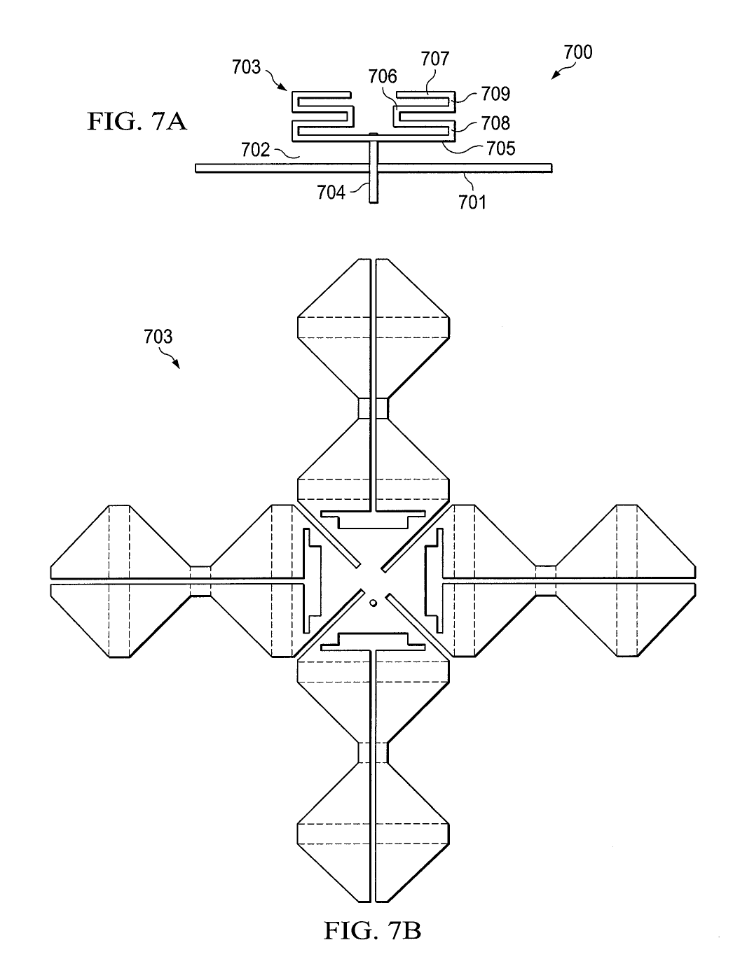

Turning now to FIGS. 6A-6B and 7A-7B, embodiments of the present invention are illustrated wherein radiating patch elements are folded multiple times to provide a plurality of horizontal layers. By increasing the number of folds, the lateral dimensions of a patch may be further reduced, allowing for more compact packaging of the folded patch antenna. Although FIGS. 6A-6B and 7A-7B present embodiments with three horizontal layers and two vertical wall layers, various embodiments of the present invention do not limit the number of times a patch radiating element may be folded.

FIG. 6A illustrates a circularly polarized folded patch antenna 600 according to one embodiment of the present invention. The embodiment shown in FIG. 6A comprises a ground plane 601, a spacer layer 602, a radiating element (patch) 603, and a feed element 604. As shown in FIG. 6A, radiating element 603 is folded to include three horizontal layers (a top layer 605, a middle layer 606, a bottom layer 607) and two vertical wall layers (first vertical wall layer 608 and second vertical wall layer 609). In this embodiment, the feed element is fed upward through space in radiating element 603 to top layer 605. FIG. 6B illustrates a plan view for radiating element 603. As shown by the dashed fold lines, radiating element 603 is designed to be folded downwards as shown in FIG. 6A.

FIG. 7A illustrates a circularly polarized folded patch antenna 700 according to an embodiment of the present invention. The embodiment shown in FIG. 7A comprises a ground plane 701, a spacer layer 702, a radiating element (patch) 703, and a feed element 704. As shown in FIG. 7A, radiating element 703 is folded to include three horizontal layers (a top layer 705, a middle layer 706, a bottom layer 707) and two vertical wall layers (first vertical wall layer 708 and second vertical wall layer 709). In this embodiment, feed element 704 is not fed through the radiating element as with the embodiment illustrated by FIG. 6A; rather, the feed element is fed directly to top layer 705. Thus, as illustrated by FIG. 6A and FIG. 7A, radiating elements according to the present invention may be folded upward or downward. FIG. 7B illustrates a plan view for radiating element 703. As shown by the dashed fold lines, radiating element 703 is designed to be folded upwards as shown in FIG. 7A.

Embodiments of the present invention are not limited to radiating elements comprised of a single conducting element. According to embodiments of the present invention the radiating element may comprise a conductor on printed circuit board (PCB) material. In other embodiments the radiating element may comprise a plurality of conducting layers connected by conducting connectors or pins.

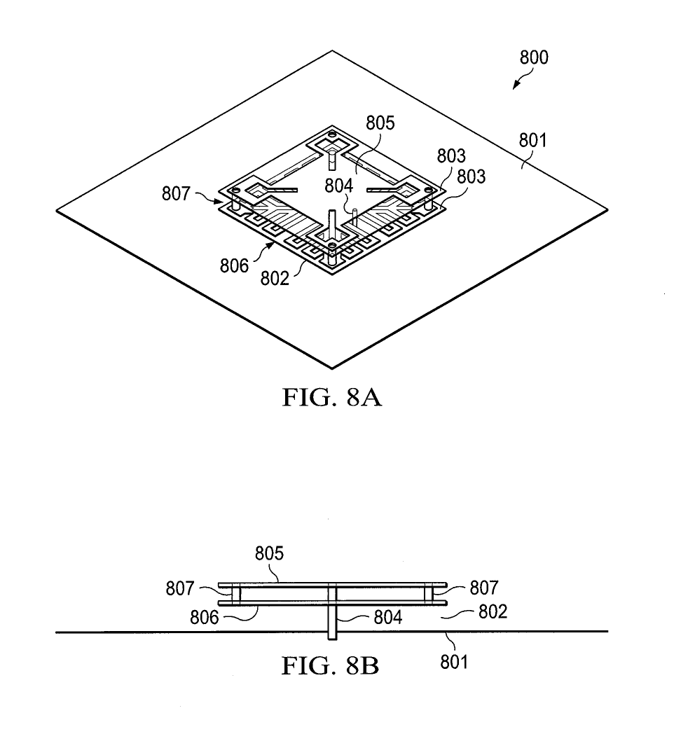

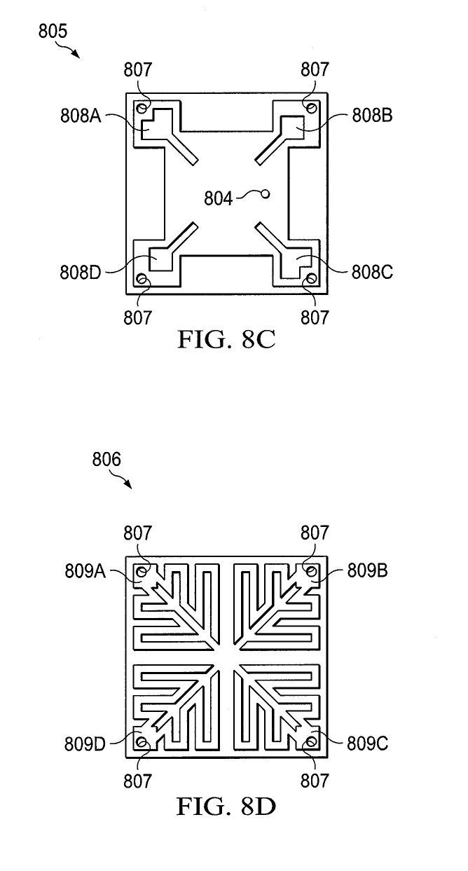

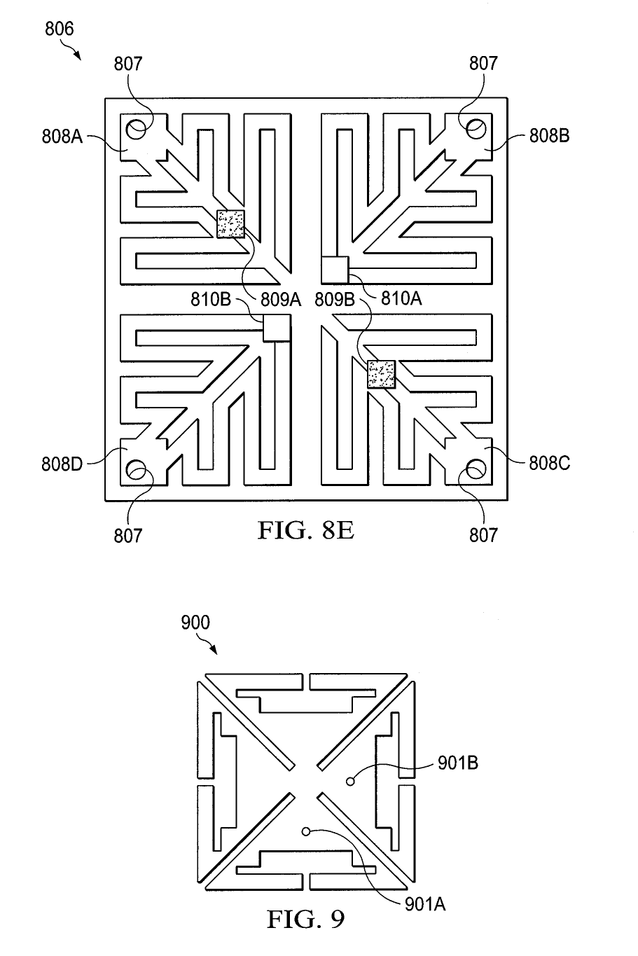

FIGS. 8A-8E illustrate a miniature circularly polarized patch antenna adapted according to an embodiment of the present invention wherein the radiating element includes conductors printed on PCB material. As illustrated in FIG. 8A, the radiating element of a circularly polarized folded patch antenna according to embodiments of the present invention can be fabricated using PCB material. The circularly polarized folded patch antenna 800 includes a ground layer 801, a spacer layer 802 (more clearly shown in FIG. 8B), a radiating element 803, and a feed element 804. In the embodiment illustrated by FIG. 8A, radiating element 803 includes a top layer 805, a bottom layer 806, and conducting pins 807.

As more clearly illustrated by FIG. 8C, top layer 805 includes an antenna pattern etched onto PCB. In the embodiment illustrated by FIGS. 8A-8D, the asymmetry in radiating element 803 is introduced in top layer 805 of radiating element 803. As shown in FIG. 8C, asymmetry is introduced at elements 808A-808D etched into top layer 805. The slots defining elements 808B and 808D are smaller than the slots defining 808A and 808C. Elements 808A-808D are selected to excite two orthogonal modes 90° out of phase and of substantially equal magnitude.

FIG. 8D illustrates bottom layer 806 according to the embodiment illustrated by FIGS. 8A-8D. As shown in FIG. 8D, each of arms 809A-809D is symmetrical in this embodiment. The radiation paths of bottom layer 806 are connected to the radiation paths of top layer 805 by conducting pins 807. In certain embodiments, as illustrated by FIG. 8E, portions of the radiation paths may be connected to alter, or tune, the radiation element. In the example of FIG. 8, tails 808A and 808C are connected at soldering points 809A and 809B and tails 808B and 808D are connected at soldering points 810A and 810B thereby tuning the response of the radiating element shown in FIGS. 8A-8E.

As illustrated in FIG. 9, embodiments of the present invention may include two orthogonal feeds. In the embodiment illustrated by FIG. 9, radiating element 900 includes dual feed points 901A and 901B, and radiating element 900 is fed two signals, one at feed point 901A and the second at feed point 901B. In embodiments utilizing a dual feed, the radiating element's geometry can be both symmetric and asymmetric. Dual feed embodiments of the present invention exhibit wider axial ratio and impedance bandwidth when fed with signals substantially equal in magnitude but 90° out of phase.

Various embodiments of the invention provide advantages over prior art antenna systems. For instance, various disclosed folded patch antennas are smaller than other air substrate CP antennas. Furthermore, various disclosed folded patch antennas do not require expensive dielectrics to facilitate miniaturization. Moreover, various disclosed miniature folded patch antennas have simple antenna structures that can be quickly and inexpensively manufactured. Although the embodiments of the present invention may be used in any number of applications, the circularly polarized folded patch antenna disclosed herein may find particular use in GPS units, satellite televisions, RFID base stations, satellite communications, cellular telephones, or other mobile communication devices.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An antenna element formed from a conductor that is shaped to provide a first layer, a wall layer, and a second layer, wherein the second layer comprises a plurality of arms under the first layer, and wherein asymmetries are present in the antenna element so that the antenna element is configured to generate and receive circularly polarized signals.

2. The antenna element of claim 1 wherein the conductive element includes a plurality of slots that create meandering radiation paths.

3. The antenna element of claim 2 wherein the asymmetries are in the first layer.

4. The antenna element of claim 2 wherein the asymmetries are in the second layer.

5. The antenna element of claim 2 wherein the asymmetries are in the wall layer.

6. The antenna element of claim 1 wherein the wall layer comprises walls of different heights.

7. The antenna element of claim 1 wherein the wall layer is constructed of items selected from the list consisting of:
a portion of a conductive layer that also forms the first layer; and
one or more conductive pins.

8. The antenna element of claim 1 wherein the conductive element is further shaped to provide a second wall layer and a third layer under the second layer.

9. A miniature folded patch antenna comprising:
an antenna element formed from a conductor that is shaped to provide a first layer, a wall layer, and a second layer, wherein the second layer comprises a plurality of arms under the first layer, and wherein asymmetries are present in the antenna element so that the antenna element is configured to generate and receive circularly polarized signals;
a ground plane separated from the antenna element by a spacer layer; and
a feed element between the antenna element and the ground plane.

10. The miniature folded patch antenna of claim 9 wherein the spacer layer comprises an air layer.

11. The miniature folded patch antenna of claim 9 wherein the miniature folded patch antenna is a component in a mobile communications device.

12. An antenna element comprising:
a conductive patch formed on a first printed circuit board;
a series of conductive patches on a second printed circuit board, wherein the conductive patch on the first printed circuit board is coupled to the series of conductive patches on the second printed circuit board by a plurality of conducting pins; and
wherein an asymmetry is present in the antenna element configuring the antenna element to transmit and receive circularly polarized signals.

13. The antenna element of claim 12 wherein the asymmetry is present in the conductive patch formed on the first printed circuit board.

14. The antenna element of claim 12 wherein the asymmetry is present in the series of conductive patches on the second printed circuit board.

15. The antenna element of claim 12 wherein the first printed circuit board and the second printed circuit board are separated by a layer of air.

16. The antenna element of claim 12 wherein the first printed circuit board and the second printed circuit board are separated by a dielectric material.

17. A patch antenna comprising:
a conductive patch formed on a first printed circuit board;
a series of conductive patches on a second printed circuit board, wherein the conductive patch on the first printed circuit board is coupled to the series of conductive patches on the second printed circuit board by a plurality of conducting pins, wherein an asymmetry is present in the series of conductive patches configuring the antenna element to transmit and receive circularly polarized signals;
a ground plane separated from the antenna element by a spacer layer; and
a radio frequency module in communication with the antenna element and transmitting and receiving radio waves through the first antenna element.

18. The patch antenna of claim 17 wherein the spacer layer comprises an air gap.

19. The patch antenna of claim 17 wherein the spacer layer includes a dielectric.

20. An antenna element formed from a single conductor that is shaped to provide a first layer, a wall layer, and a second layer, wherein the second layer comprises a plurality of arms folded under the first layer, and wherein asymmetries are present in the antenna element so that the antenna element is configured to generate and receive circularly polarized signals.

21. The antenna element of claim 20 wherein the conductive element includes a plurality of slots that create meandering radiation paths.

22. The antenna element of claim 20 wherein the antenna element is further shaped to provide a second wall layer and a third layer under the second layer.

23. The antenna element of claim 22 wherein the asymmetries are in the third layer.

24. A method of making a radiating element for a patch antenna comprising:
providing a flat conductor;
forming an antenna element from the flat conductor, wherein a pattern of the antenna element includes a plurality of slots and asymmetries that cause a signal fed to the antenna element to degenerate into two modes; and
manipulating the antenna element about a first set of generally parallel fold lines so as to form a top layer, a wall layer, and a bottom layer.

25. The method of claim 24 wherein the asymmetries are in the top layer.

26. The method of claim 24 wherein the asymmetries are in the bottom layer.

27. The method of claim 24 wherein the asymmetries are in the wall layer.

28. The method of claim 24 further comprising: tuning the antenna element by electrically connecting portions of the pattern.
